(19) United States
(12) Patent Application Publication
(10) Pub. No.: US 2020/0274920 A1
(43) Pub. Date: Aug. 27, 2020

(54) SYSTEM AND METHOD TO PERFORM PARALLEL PROCESSING ON A DISTRIBUTED DATASET

(71) Applicant: HCL TECHNOLOGIES LIMITED, Noida (IN)

(72) Inventors: S U M Prasad DHANYAMRAJU, Hyderabad (IN); Sriganesh SULTANPURKAR, Hyderabad (IN); Vamsi PEDDIREDDY, Hyderabad (IN); Deepthi Priya BEJJAM, Hyderabad (IN)

(73) Assignee: HCL TECHNOLOGIES LIMITED, Noida (IN)

(21) Appl. No.: 16/791,355

(22) Filed: Feb. 14, 2020

(30) Foreign Application Priority Data
Feb. 25, 2019 (IN) 201911007296

(51) Int. Cl. H04L 29/08; G06F 9/451

(52) U.S. Cl. CPC H04L 67/10; G06F 9/453

(57) ABSTRACT

Disclosed is a system to perform parallel processing on a distributed dataset. A receiving module, for receiving a dataset along with a set of functions. A partitioning module, for partitioning the dataset into a set of distributed datasets. A distributing module, for distributing the set of distributed datasets amongst a set of computing nodes. A determining module, for determining an applicability of the function on the distributed dataset. An executing module, for executing one or more functions applicable on the distributed dataset. A generating module, for generating processed data for the distributed dataset based upon the executing of the one or more functions.

### CROSS-REFERENCE TO RELATED APPLICATIONS AND PRIORITY

The present application claims benefit from Indian Complete Patent Application No. 201911007296 filed on 25 Feb. 2020 the entirety of which is hereby incorporated by reference.

### TECHNICAL FIELD

The present subject matter described herein, in general, relates to performing parallel processing on a distributed dataset.

### BACKGROUND

In the wake of analytics popularity and prevalent big data archives and systems, several analytics development and deployment systems are emerging such as cloud analytics, edge analytics, fog analytics and embedded analytics. There are multiple functions to perform analytic operations that are added daily on generic libraries. The generic libraries may include, but not limited to, libraries of Java, Scala, Python and R programming languages. The generic libraries are too vast and widely used in analytics experiments and further for data cleaning, data preprocessing and data postprocessing.

All the generic libraries are developed to execute on a standalone or a single system and run without hindrance when the data is small or in tens of gigabytes. But when the generic libraries are executed on terabytes of data, they are executed in a distributed environment. Further, when it comes to execute the generic libraries in a distributed environment, the generic libraries have to be re-written to the required distributed environment natively.

### SUMMARY

Before the present systems and methods to perform parallel processing on a distributed dataset, are described, it is to be understood that this application is not limited to the particular systems, and methodologies described, as there can be multiple possible embodiments for performing parallel processing on a distributed dataset which are not expressly illustrated in the present disclosure. It is also to be understood that the terminology used in the description is for the purpose of describing the particular versions or embodiments for performing parallel processing on the distributed dataset only and is not intended to limit the scope of the present application. This summary is provided to introduce concepts related to systems and methods for performing parallel processing on the distributed dataset and the concepts are further described below in the detailed description. This summary is not intended to identify essential features of the claimed subject matter nor is it intended for use in determining or limiting the scope of the claimed subject matter.

In one implementation, a method for performing parallel processing on a distributed dataset is disclosed. The method may be performed, initially by receiving a dataset along with a set of functions. After receiving, the dataset may be partitioned into a set of distributed datasets using a distributed data processing technology. The set of distributed datasets may be distributed amongst a set of computing nodes. A distributed dataset may be stored on a computing node. After distributing the set of distributed datasets, an applicability of the function on the set of distributed datasets may be determined. The determination may be based on at least one of an argument type and an argument default value. The argument type and the argument default value may be associated with the function. After determining one or more functions applicable on the distributed dataset, the one or more functions may be executed on the distributed dataset. The execution of the one or more functions may be performed concurrently on the set of computing nodes. The execution of one or more functions on the distributed dataset may generate a processed dataset for the distributed dataset.

In another implementation, a system for performing parallel processing on a distributed dataset is disclosed. The system may comprise of a receiving module, a partitioning module, a distributing module, a determining module, an executing module and a generating module. The receiving module may receive, a dataset along with a set of functions. After receiving the dataset, the partitioning module may partition the dataset into a set of distributed datasets using a distributed data processing technology. The distributing module may distribute the set of distributed datasets amongst a set of computing nodes. The distributing module stores a distributed dataset on a computing node. After distributing the datasets, the determining module may determine an applicability of the function on the distributed dataset. The applicability of the function may be determined based upon at least one of an argument type and an argument default value. The argument type and the argument default value may be associated to the function. After determining the applicability of the function by the determining module, the executing module may execute one or more functions applicable on the distributed dataset. The one or more functions may be executed concurrently on the set of computing nodes. The generation module may generate processed data for the distributed dataset based upon executing the one or more functions on the distributed dataset.

In yet another implementation, non-transitory computer readable medium embodying a program executable in a computing device for performing parallel processing on distributed dataset is disclosed. The program code may receive, a dataset along with a set of functions. After receiving the dataset, the program code may partition the dataset into a set of distributed datasets using a distributed data processing technology. The program code may distribute the set of distributed datasets amongst a set of computing nodes. The program code stores a distributed dataset on a computing node. After distributing the datasets, the program code may determine an applicability of the function on the distributed dataset. The applicability of the function may be determined based upon at least one of an argument type and an argument default value. The argument type and the argument default value may be associated to the function. After determining the applicability of the function by the program code, the program code may execute one or more functions applicable on the distributed dataset. The one or more functions may be executed concurrently on the set of computing nodes. The program code may generate processed data for the distributed dataset based upon executing the one or more functions on the distributed dataset.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus to perform parallel processing on a distributed dataset disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for performing parallel processing on a distributed dataset, in accordance with an embodiment of the present subject matter.

FIG. 2 illustrates a hardware implementation of a system for performing parallel processing on a distributed dataset, in accordance with an embodiment of the present subject matter.

FIG. 3 illustrates a method for performing parallel processing on a distributed dataset using a system, in accordance with an embodiment of the present subject matter.

### DETAILED DESCRIPTION

Some embodiments of this disclosure, illustrating all its features, will now be discussed in detail. The words “receiving”, “partitioning”, “distributing”, “determining”, “executing”, “generating” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any systems and methods similar or equivalent to those performing parallel processing on a distributed dataset described herein can be used in the practice or testing of embodiments of the present disclosure, the exemplary, systems and methods are now described. The disclosed embodiments are merely exemplary of the disclosure, which may be embodied in various forms.

Various modifications to the embodiment of performing parallel processing of the distributed dataset will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

While aspects of described system and method for performing parallel processing on the distributed dataset may be implemented in any number of different computing systems, environments, and/or configurations, the embodiments are described in the context of the following exemplary system for performing parallel processing on the distributed dataset.

The present disclosure elaborates a system and a method for performing parallel processing on a distributed dataset. To perform parallel processing on a distributed dataset, initially a dataset along with a set of functions may be received. The dataset indicates a file that is a collection of elements in at least one of an unstructured form or a structured form. The unstructured form indicates a heterogeneous collection of data whereas the structured form indicates the dataset in a tabulated or indexed form. Further, the set of functions may indicate type of predictive, prescriptive or descriptive analytics based on the dataset. After receiving the dataset along with a set of functions, the dataset may be partitioned into a set of distributed datasets.

After partitioning, the set of distributed datasets may be distributed amongst a set of computing nodes. A distributed dataset may be stored on a computing node. The dataset stored on the computing nodes may undergo certain transformation with the help of certain functions. Therefore, after distributing datasets, an applicability of a function on a dataset may be determined. The applicability of the function may be determined based upon at least one of an argument type and an argument default value. The argument type and the argument default value may be associated to the function that is to be applied. After determining the applicability of the set of functions, one or more functions that are be applicable on the distributed dataset may be executed. The execution operation may be performed concurrently on the set of computing nodes. The execution of one or more functions on the distributed dataset may generate processed data for that distributed dataset.

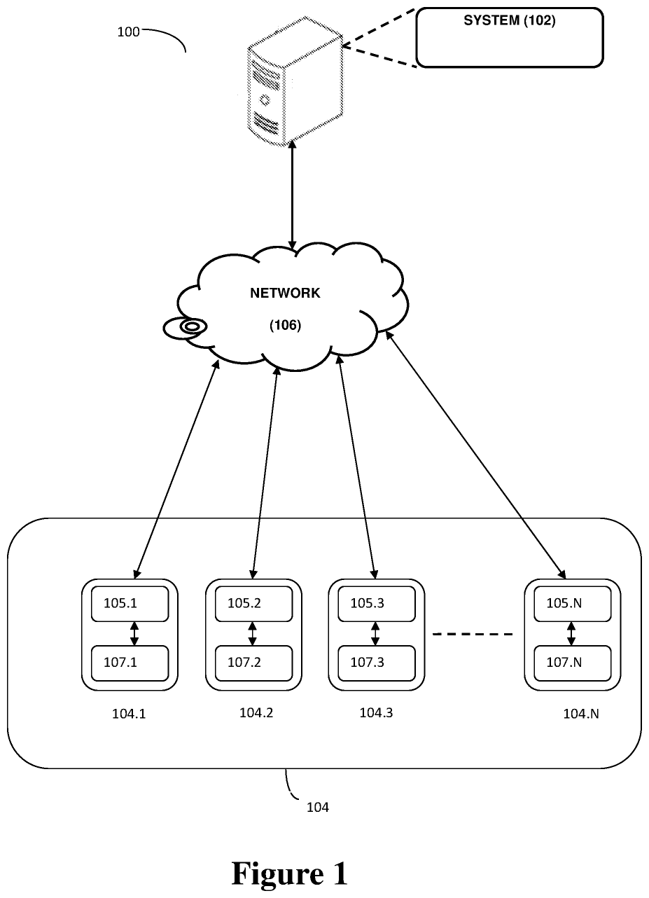

### FIG. 1 Description:

Referring now to FIG. 1, a network implementation 100 of a system 102 for performing parallel processing on a distributed dataset is disclosed. Although performing parallel processing on the distributed dataset is explained considering that the system 102 is implemented on a server, it may be understood that the system 102 may also be implemented in a variety of computing systems, such as a laptop computer, a desktop computer, a notebook, a workstation, a mainframe computer, a server, a network server, embedded hardware platform board, reprogrammable device platform and the like. In one implementation, the system 102 for performing parallel processing on a distributed dataset may be implemented over a cloud network. Further, it will be understood that the system 102 may access multiple user systems of one or more 104-1, 104-2 . . . 104-N, collectively referred to as user system 104.

Considering the user system 104.1, the user system comprises computing system 105.1 and a database 107.1. The user system 104 may be communicatively coupled to system 102 through the network 106. The computing systems 105.1, 105.2 to 105.N may hereinafter be collectively referred to as the computing system 105. The databases 107.1, 107.2 to 107.N, may hereinafter collectively be referred to as the database 107. The computing system 105 may include but not limited to laptop computer, a desktop computer, a notebook, a workstation. The dataset may be stored on the database 107. In one embodiment, the dataset may indicate a Bigdata. The Bigdata may be classified based on volume and variety. In terms of volume, the bigdata may correspond to a minimum size of one terabyte that may extend up to a size of zettabyte. In terms of variety, the bigdata may comprise unstructured data in the form of social media posts, images and video to time series IoT data. The database 107 that store the bigdata may comprise NoSQL type database. Examples of database 107 may include, but not limited to MongoDB™, CouchDB™, Couchbase™ Cassandra™.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the system 102 may receive a dataset from the database 107. The dataset may include at least a JavaScript Object Notation (JSON) file, a Comma-Separated Values (CSV) file, a text file or a database via a Java Database Connectivity (JDBC) Application Program Interface (API) with no specific data structure, or any other similar form of file. The system 102 along with the dataset, may receive a set of functions from the computing system 105 via the network 106. The set of functions may be associated to a library of a programming language. The set of functions may indicate a type of predictive, prescriptive or descriptive analytics that may be performed on the dataset.

The programming language may be compatible with the distributed data processing technology. The distributed data processing technology may be installed on the system 102. In one embodiment, the distributed data processing technology may indicate Apache Spark® engine. The Apache Spark® engine is an open-source engine that may perform analytics on the dataset. The dataset in the embodiment may indicate the Bigdata. The analytics on bigdata indicate applying functions on the bigdata. The functions may be associated to the library of the programming language that may be compatible with Apache Spark®. The programming languages that may be compatible with Apache Spark® includes, but not limited to Java, Python, Scala, Structured Query Language (SQL) and R.

After receiving the dataset, the system 102 may partition the dataset into a set of distributed datasets. The partitioning may be performed by the distributed data processing technology. In one implementation, when the distributed data processing technology may be Apache Spark®, the set of distributed datasets indicate a set of Resilient Distributed Datasets (RDD). The Apache Spark® partitions the dataset into a set of RDD. The set of RDD may be collection of logical partitions across the dataset.

The system 102 after partitioning the dataset into a set of distributed datasets, may distribute the set of distributed datasets amongst a set of computing nodes. The system 102, may store a distributed dataset on a computing node. The set of computing nodes may indicate a set of logical partitions in a volatile memory. A partition may act as a separate computing element. The computing node may indicate a computing element in the system 102. In one aspect, the set of computing nodes represents an Apache Spark® cluster having a single master and a set of several slaves corresponding to the single master.

After distributing the set of distributed datasets amongst a set of computing nodes, the system 102 may further determine the applicability of a function on the distributed dataset. The function comprises an argument type and an argument default value. For example, consider a function in python “sklearn.tree.DecisionTreeClassifier (criterion=‘gini’, splitter=‘best’,max_depth=None,min_samples_split=2,min_samples_leaf=1,min_weight_fract ion_leaf=0.0,max_features=None,random_state=None,max_leaf_nodes=None,class_weight=None, presort=False)”. The function has twelve argument types.

The system 102 may determine the applicability of the function based on at least one of the argument type and the argument default value. The applicability of the function may be determined based on a set of help functions associated with the library of the programming language. For example, considering the python as the programming language, the set of help functions associated to the library of the python may indicate the python docstrings.

In one embodiment, a wrapper may be used to determine the applicability of the function on the distributed dataset. The wrapper takes input as the argument type and the argument default value of the function. The wrapper using the set of help functions of the library of the programming language creates a function object to be applied on the distributed dataset. For example, considering the python function sklearn.tree.DecisionTreeClassfier, the wrapper may use the python docstrings to create the function object (obj.function) to be applied on the distributed dataset. In Apache Spark® a map partition function may be used to distribute the function on the set of distributed datasets. The map partition function for the Apache Spark® may indicate a rdd.mapPartition function. The map partition function may take the function object and distribute the function over the set of distributed datasets.

The system 102 after determining the applicability of the function on the distributed dataset, may execute one or more functions applicable on the distributed dataset. The one or more functions applicable on the distributed dataset may be executed concurrently on the set of computing nodes. After executing the one or more functions, a processed data may be generated by the system 102. In one aspect, the processed may be stored on the computing node where the processed dataset is generated. In another aspect, the processed data may be stored to the database 107 via network 106.

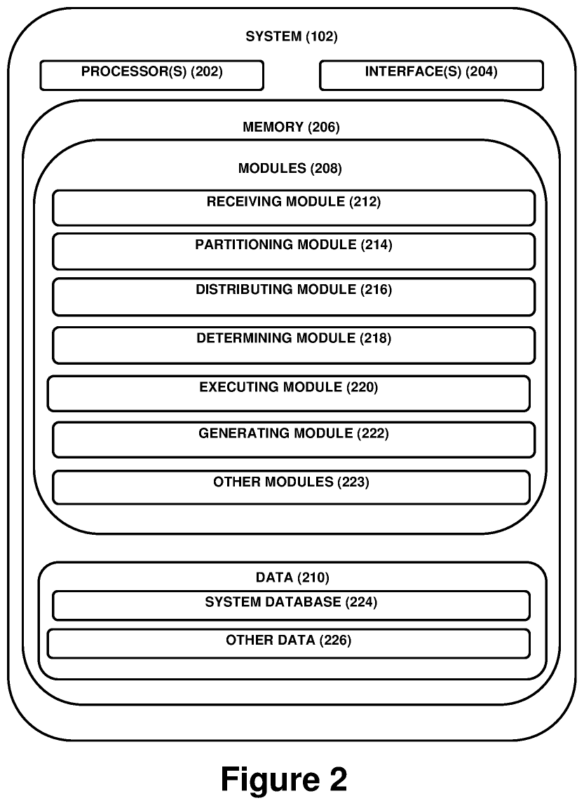

### FIG. 2 Description:

Referring now to FIG. 2, a hardware implementation of a system 102 for performing parallel processing on a distributed dataset is disclosed. Referring now to FIG. 2, the system 102 is illustrated in accordance with an embodiment of the present subject matter. In one embodiment, the system 102 for performing parallel processing on the distributed dataset may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user system directly. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a receiving module 212, a partitioning module 214, a distributing module 216, a determining module 218, an executing module 220, a generating module 222 and other modules 223. The other modules 223 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a system database 224 and other data 226. The other data 226 may include data generated as a result of the execution of one or more modules in the other modules 223.

The system 102 to perform parallel processing on the distributed dataset facilitates in accelerating analytic operations that may be required to be performed on a dataset. The types of analytic operations on the dataset may include but not limited to, descriptive, predictive and prescriptive analytics on the distributed dataset. The system 102 may register a user system from the I/O interface 204 to use the system 102. The system may, further, receive inputs from the user system through the I/O interface 204. In one aspect, the user system may access the I/O interface 204 of the system 102. The system 102 may employ the receiving module 212, the partitioning module 214, the distributing module 216, the determining module 218, the executing module 220 and the generating module 222 to perform parallel processing on the distributed dataset.

### Receiving Module 212:

The receiving module 212, may receive a dataset and a set of functions that may be applied on the dataset. The dataset may include at least a JavaScript Object Notation (JSON) file, Comma-Separated Values (CSV) file, text file or database via Java Database Connectivity API (JDBC) with no specific data structure. The functions indicate a set of analytic operations that may be applied on the dataset. The analytic operations may include, but not limited to descriptive, predictive, prescriptive analytics of the distributed dataset. The functions may belong to a library of a programming language. Further, the programming language may be compatible with a distributed data processing technology.

In one implementation, the distributed data processing technology may indicate Apache Spark®. The programming languages that may be compatible with Apache Spark® include, but not limited to Java, Python, Scala, R programming languages. Apache Spark® is an open source engine that may perform analytic operations on a bigdata. Further, the programming language that comprise the functions may include those programming languages that run on Apache Spark™. The languages may include, but not limited to, Java, Python, Scala, SQL, R programming languages.

### Partitioning Module 214:

After receiving the dataset, the partitioning module 214 may partition the dataset into a set of distributed datasets. The dataset may be partitioned using the distributed data processing technology. In one aspect, the distributed data processing technology may be Apache Spark® distribution engine. When the Apache Spark® engine is used the set of distributed datasets may indicate a set of Resilient Distributed Datasets (RDD). The set of RDD may be a collection of logical partitions across the dataset.

### Distributing Module 216:

After partitioning the dataset into the set of distributed datasets, the distributing module 216 may distribute the set of distributed datasets amongst a set of computing nodes. The distributing module 216 may store a distributed dataset on a computing node. The set of computing nodes may indicate a set of logical partitions in a volatile memory. A partition may act as a separate computing element. The computing node may indicate a computing element in the system 102. In one embodiment, the cluster of nodes represents an Apache Spark® cluster having a single master and several slaves corresponding to the single master.

Determining module 218:

After the distributing module 216 distributes the set of distributed datasets, the determining module 218 determines a function applicable on the distributed dataset. The function comprises an argument type and an argument default value. For example consider a function in python “sklearn.tree.DecisionTreeClassifier (criterion=‘gini’, splitter=‘best’,max_depth=None,min_samples_split=2,min_samples_leaf=1,min_weight_fract ion_leaf=0.0,max_features=None,random_state=None,max_leaf_nodes=None,class_weight=None, presort=False)”. The function has twelve argument types and argument default values. The argument type in the function includes criterion, splitter and the argument default values include class_weight, max_leaf_none.

The determining module 218 may determine the applicability of the function based on at least one of the argument type and argument default value. The determining module 218 may analyze the argument type and argument default value based on a set of help functions associated to the library of the programming language. For example, if the programming language is python, the set of help functions indicate python docstrings.

In one embodiment, the determining module 218 may indicate a wrapper. The wrapper may be used to determine the applicability of the function on the distributed dataset. The wrapper takes input as the argument type and the argument default value of the function. The wrapper using the set of help functions of the library of the programming language creates a function object to be applied on the distributed dataset. For example, considering the python function sklearn.tree.DecisionTreeClassfier, the wrapper using the python docstrings to create the function object (obj.function) to be applied on the distributed dataset. In one aspect when the distributed data processing technology may be Apache Spark®, a map partition function may be used to distribute the function on the set of distributed datasets. The map partition function for the Apache Spark® indicates a rdd.mapPartition function. The map partition function may take the function object and distribute the function over the set of distributed datasets.

### Executing Module 220:

After determining the applicability of the function, the executing module 218 may execute one or more functions applicable on the distributed dataset. The executing module 218 may execute the one or more functions concurrently on the set of computing nodes. The execution of one or more functions concurrently indicate parallel processing on the set of distributed datasets.

Generating module 222:

After executing the one or more functions, the generating module 222 may generate processed data for the distributed dataset. The generation module generates a set of processed data for the set of distributed datasets concurrently. In one aspect, the set of processed datasets may be stored on the computing node where the processed dataset is generated.

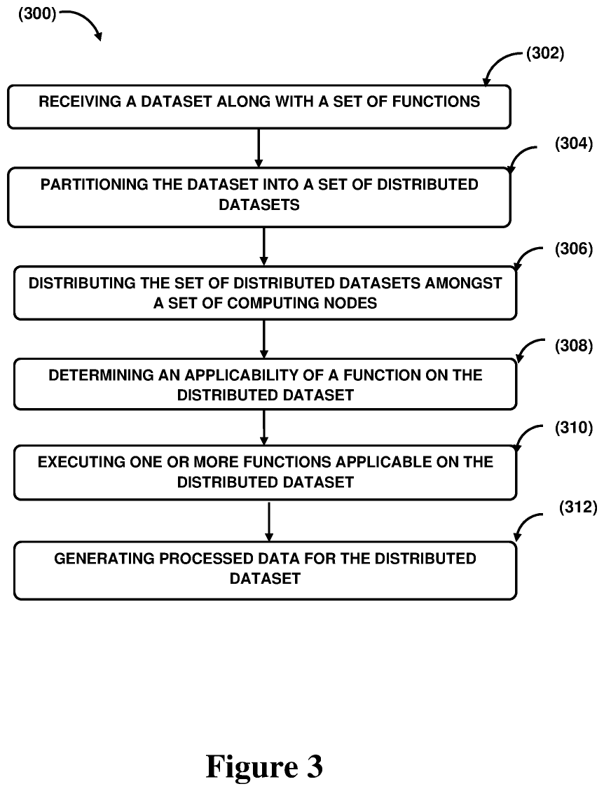

### FIG. 3 Description:

Referring now to FIG. 3, a method 300 for parallel processing on a distributed dataset is shown, in accordance with an embodiment of the present subject matter. The method 300 may be described in the general context of computer executable instructions. Generally, computer executable instructions can include routines, programs, objects, components, data structures, procedures, modules, functions, etc., that perform functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 for performing parallel processing on a distributed dataset may be implemented as described in the system 102.

At block 302, a dataset along with a set of functions may be received. In one implementation, a dataset along with a set of functions may be received by a receiving module 212 and linked to system database 224.

At block 304, the dataset may be partitioned into a set of distributed datasets using a distributed data processing technology. In one implementation, the dataset may be partitioned by a partitioning module 214 and stored to system database 224.

At block 306, the set of distributed datasets may be distributed amongst a set of computing nodes. In one implementation, the set of distributed datasets may be distributed by a distributing module 216 and tied to system database 224.

At block 308, an applicability of the function may be determined on the distributed dataset. The applicability may be determined based upon at least one of an argument type and argument default value. In one implementation, the applicability of the function may be determined by a determining module 218 and tied to system database 224.

At block 310, one or more functions applicable on the distributed dataset may be executed. In one implementation, the applicability on the distributed dataset may be executed by the executing module 220 and tied to system database 224.

At block 312, processed dataset may be generated for the distributed dataset upon executing the one or more functions on the distributed dataset. In one implementation, the processed data may be generated by the generating module 222 and tied to system database 224.

Exemplary embodiments discussed above may provide certain advantages. Though not required to practice aspects of the disclosure, these advantages may include those provided by the following features.

Some embodiments enable a system and a method to perform parallel processing for at least one of structured dataset and unstructured dataset.

Some embodiments enable a system and a method to perform standalone transformations of dataset to distributed dataset.

Although implementations for methods and systems for performing parallel processing on the distributed dataset have been described in language specific to structural features and/or methods, it is to be understood that the appended claims are not necessarily limited to the specific features or methods described. Rather, the specific features and methods are disclosed as examples of implementations for performing parallel processing on the distributed dataset using the system.

1. A method for performing parallel processing on a distributed dataset, the method comprising:
receiving, by a processor, a dataset along with a set of functions;
partitioning, by the processor, the dataset into a set of distributed datasets using a distributed data processing technology;
distributing, by the processor, the set of distributed datasets amongst a set of computing nodes, wherein a distributed dataset is stored on a computing node;
determining, by the processor, an applicability of a function on the distributed dataset, wherein the applicability of the function is determined based upon at least one of an argument type and an argument default value associated to the function;
executing one or more functions applicable on the distributed dataset, wherein the one or more functions are executed concurrently on the set of computing nodes; and
generating, by the processor, processed data for the distributed dataset based upon the executing of the one or more functions.

2. The method of claim 1, wherein the set of functions are associated to a library of a programming language compatible with the distributed data processing technology.

3. The method of claim 1, wherein the applicability of the function is determined based on a set of help functions associated with a library of a programming language compatible with the distributed data processing technology.

4. The method of claim 1, further comprising storing the processed data on the computing node.

5. A system for performing parallel processing on a distributed dataset, the system comprising:
a receiving module, for receiving a dataset along with a set of functions; a partitioning module, for partitioning the dataset into a set of distributed datasets using a distributed data processing technology;
a distributing module, for distributing the set of distributed datasets amongst a set of computing nodes, wherein a distributed dataset is stored on a computing node;
a determining module, for determining an applicability of a function on the distributed dataset, wherein the applicability of the function is determined based upon at least one of an argument type and an argument default value associated to the function;
an executing module, for executing one or more functions applicable on the distributed dataset, wherein the one or more functions are executed concurrently on the set of computing nodes; and
a generating module, for generating, processed data for the distributed dataset based upon the executing of the one or more functions.

6. The system of claim 5, wherein the set of functions are associated to a library of a programming language compatible with the distributed data processing technology.

7. The system of claim 5, wherein the applicability of the function is determined based on a set of help functions associated with a library of a programming language compatible with the distributed data processing technology.

8. The system of claim 5, further comprising storing the processed data on the computing node.

9. A non-transitory computer readable medium embodying a program executable in a computing device for performing parallel processing on a distributed dataset, the program comprising a program code for:
receiving, by a processor, a dataset along with a set of functions;
partitioning, by the processor, the dataset into a set of distributed datasets using a distributed data processing technology;
distributing, by the processor, the set of distributed datasets amongst a set of computing nodes, wherein a distributed dataset is stored on a computing node;
determining, by the processor, an applicability of a function on the distributed dataset, wherein the applicability of the function is determined based upon at least one of an argument type and an argument default value associated to the function; and
executing one or more functions applicable on the distributed dataset, wherein the one or more functions are executed concurrently on the set of computing nodes;
generating, by the processor, processed data for the distributed dataset based upon the executing of the one or more functions.
